(19) United States
(12) Patent Application Publication
(10) Pub. No.: US 2026/0093021 A1
(43) Pub. Date: Apr. 2, 2026

(54) ULTRASOUND PROBE

(71) Applicant: FUJIFILM Corporation, Tokyo (JP)

(72) Inventors: Shinsuke NOGUCHI, Kanagawa (JP); Keiji TSUBOTA, Kanagawa (JP)

(73) Assignee: FUJIFILM Corporation, Tokyo (JP)

(21) Appl. No.: 19/316,565

(22) Filed: Sep. 2, 2025

(30) Foreign Application Priority Data
Sep. 30, 2024 (JP) 2024-170311

(51) Int. Cl. G01S 7/52

(52) U.S. Cl. CPC G01S 7/52096; G01S 7/52079

(57) ABSTRACT

Provided is a wireless-charging ultrasound probe that can improve charging efficiency of a built-in battery.

An ultrasound probe includes a housing that has a grip portion disposed between a front end portion and a rear end portion, a transducer array that is disposed inside the front end portion of the housing, a battery that is disposed inside the housing, and a power receive coil that has a flat plate shape, that is disposed inside the grip portion of the housing, and that is connected to the battery, in which the housing has four side plate portions that each extend along a center line extending from the front end portion to the rear end portion and that surround the grip portion, the power receive coil is disposed along an inner surface of a first side plate portion among the four side plate portions, and at least a region of the first side plate portion in which the power receive coil is disposed has a planar outer surface.

### CROSS-REFERENCE TO RELATED APPLICATIONS

The present application claims priority under 35 U.S.C. § 119 to Japanese Patent Application No. 2024-170311, filed on Sep. 30, 2024. The above application is hereby expressly incorporated by reference, in its entirety, into the present application.

### BACKGROUND OF THE INVENTION

### 1. Field of the Invention

The present invention relates to an ultrasound probe, and more particularly to a wireless-charging ultrasound probe in which a built-in battery is charged in a wireless manner.

### 2. Description of the Related Art

In related art, an ultrasound diagnostic apparatus using ultrasound images is put into practical use in the medical field. In general, such an ultrasound diagnostic apparatus comprises an ultrasound probe in which a transducer array is built and a diagnostic apparatus body connected to the ultrasound probe, in which an ultrasound image is generated by transmitting an ultrasound beam from the ultrasound probe toward a subject, receiving an ultrasound echo from the subject by the ultrasound probe, and electrically processing the received signal, for example, in the diagnostic apparatus body.

As disclosed in WO2020/075574A, in recent years, an ultrasound diagnostic apparatus in which a battery is built in an ultrasound probe, and the ultrasound probe and a diagnostic apparatus body are wirelessly connected to each other by wireless communication has been developed.

In such an ultrasound diagnostic apparatus, a cable for connecting the ultrasound probe and the diagnostic apparatus body is not required, so that the operability and mobility of the ultrasound probe by a user can be improved.

However, in a case in which the battery built in the ultrasound probe is charged, it is necessary to connect an alternating current (AC)/direct current (DC) adapter, a universal serial bus (USB) cable, or the like to the ultrasound probe.

Therefore, JP2012-196303A discloses a wireless-charging ultrasound probe. Power is supplied from a charger built in the diagnostic apparatus body or a charger disposed separately from the diagnostic apparatus body to a power reception unit built in the ultrasound probe in a wireless manner, and the battery in the ultrasound probe is charged using the power.

### SUMMARY OF THE INVENTION

However, it is known that the charging efficiency deteriorates rapidly as a distance between the charger and the power reception unit of the ultrasound probe increases. Therefore, it is desired to efficiently charge the battery by bringing the charger and the power reception unit of the ultrasound probe as close to each other as possible in a case of charging the battery.

The present invention has been made in order to solve such a problem in the related art, and an object of the present invention is to provide a wireless-charging ultrasound probe that can improve charging efficiency of a built-in battery.

The above object can be achieved with the following configurations.
[1] An ultrasound probe as a wireless-charging ultrasound probe that charges a battery built in the ultrasound probe in a wireless manner, the ultrasound probe comprising: a housing that has a front end portion and a rear end portion, and a grip portion disposed between the front end portion and the rear end portion; a transducer array that is disposed inside the front end portion of the housing; the battery that is disposed inside the housing; and a power receive coil that has a flat plate shape and that is disposed inside the grip portion of the housing, in which the housing has four side plate portions that each extend along a center line extending from the front end portion to the rear end portion and that surround the grip portion, and the power receive coil is disposed along an inner surface of a first side plate portion among the four side plate portions, and at least a region of the first side plate portion in which the power receive coil is disposed has a planar outer surface.
[2] The ultrasound probe according to [1], in which at least a part of an outer surface of a second side plate portion, among the four side plate portions, disposed on a side opposite to the first side plate portion with the center line interposed therebetween has a curved shape.
[3] The ultrasound probe according to [2], further comprising: a circuit board that is disposed inside the second side plate portion.
[4] The ultrasound probe according to [3], further comprising: a heat dissipation member that is disposed between the circuit board and an inner surface of the second side plate portion.
[5] The ultrasound probe according to [2], further comprising: a wireless communication circuit that is disposed inside the second side plate portion.
[6] The ultrasound probe according to [5], further comprising: a heat dissipation member that is disposed between the wireless communication circuit and an inner surface of the second side plate portion.
[7] The ultrasound probe according to any one of [2] to [6], further comprising: a protrusion that indicates an orientation of the ultrasound probe and that is disposed on an outer surface of a third side plate portion, among the four side plate portions, located on a left side of the second side plate portion toward the transducer array or an outer surface of a fourth side plate portion, among the four side plate portions, located on a right side of the second side plate portion toward the transducer array.
[8] The ultrasound probe according to [7], further comprising: a light-emitting unit that is disposed on the outer surface of the third side plate portion or the outer surface of the fourth side plate portion.
[9] The ultrasound probe according to [7], further comprising: an operation button that is disposed on the outer surface of the third side plate portion or the outer surface of the fourth side plate portion.
[10] The ultrasound probe according to [4], further comprising: a temperature sensor that is connected to the circuit board and that is disposed close to the inner surface of the second side plate portion, in which the heat dissipation member has an opening portion formed corresponding to a position at which the temperature sensor is disposed.

The ultrasound probe comprises: the housing that has the front end portion and the rear end portion, and the grip portion disposed between the front end portion and the rear end portion; the battery that is disposed inside the housing; and the power receive coil that has the flat plate shape, that is disposed inside the grip portion of the housing, and that is connected to the battery, the housing has four side plate portions that each extend along the center line extending from the front end portion to the rear end portion and that surround the grip portion, and the power receive coil is disposed along an inner surface of a first side plate portion among the four side plate portions, and at least the region of the first side plate portion in which the power receive coil is disposed has the planar outer surface, so that it is possible to improve the charging efficiency of the built-in battery.

### BRIEF DESCRIPTION OF THE DRAWINGS

FIG. 1 is a perspective view showing an ultrasound probe according to a first embodiment of the present invention.

FIG. 2 is a plan view showing the ultrasound probe according to the first embodiment of the present invention.

FIG. 3 is a side view showing the ultrasound probe according to the first embodiment of the present invention.

FIG. 4 is a cross-sectional view showing an internal configuration of the ultrasound probe according to the first embodiment of the present invention.

FIG. 5 is a block diagram showing a configuration of an ultrasound diagnostic apparatus comprising the ultrasound probe according to the first embodiment of the present invention.

FIG. 6 is a block diagram showing an internal configuration of a transmission/reception circuit of the ultrasound probe according to the first embodiment of the present invention.

FIG. 7 is a block diagram showing an internal configuration of an image generation unit of the ultrasound probe according to the first embodiment of the present invention.

FIG. 8 is a diagram showing the ultrasound probe and an apparatus body according to the first embodiment held by a holding stand.

FIG. 9 is a diagram showing the ultrasound probe according to the first embodiment held by a probe holder of the holding stand.

FIG. 10 is a block diagram showing an internal configuration of the ultrasound probe and a charger according to the first embodiment during charging.

FIG. 11 is a plan view showing the ultrasound probe according to the first embodiment held by another charger.

FIG. 12 is a side view showing the ultrasound probe according to the first embodiment held by the other charger.

FIG. 13 is a side view showing an ultrasound probe according to a second embodiment of the present invention.

FIG. 14 is a block diagram showing a configuration of an ultrasound diagnostic apparatus comprising the ultrasound probe according to the second embodiment of the present invention.

FIG. 15 is a block diagram showing a configuration of an ultrasound diagnostic apparatus comprising an ultrasound probe according to a third embodiment of the present invention.

### DESCRIPTION OF THE PREFERRED EMBODIMENTS

Hereinafter, embodiments of the present invention will be described with reference to the drawings.

The following configuration requirements are described based on representative embodiments of the present invention, but the present invention is not limited to the embodiment.

In the present specification, a numerical range represented by “to” means a range including numerical values described before and after “to”, both ends inclusive, as lower limit and upper limit values.

In the present specification, “same” and “identical” include an error range which is generally allowed in the technical field.

### First Embodiment

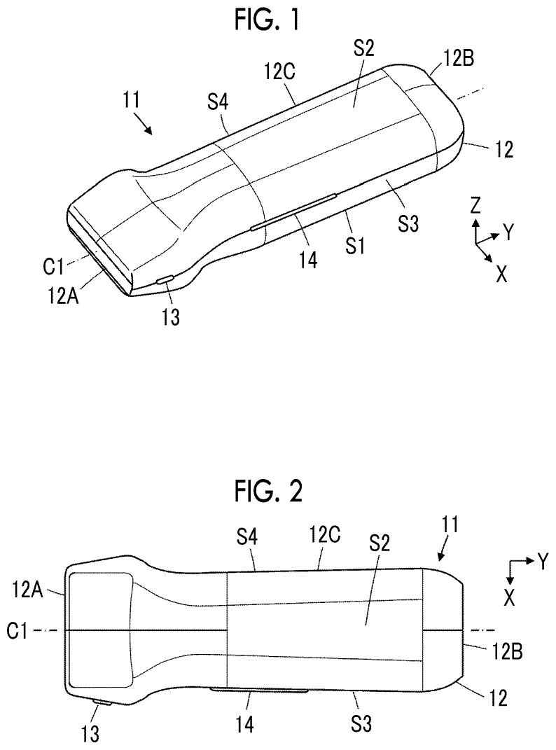

FIGS. 1 to 3 show an ultrasound probe 11 according to a first embodiment of the present invention. The ultrasound probe 11 comprises a housing 12, and the housing 12 extends in a predetermined direction as a whole and has a flat and wide shape. The housing 12 has a front end portion 12A disposed at one end portion in an extending direction, a rear end portion 12B disposed at the other end portion, and a grip portion 12C disposed between the front end portion 12A and the rear end portion 12B. The grip portion 12C is a portion gripped by a user in a case in which ultrasound diagnosis is performed using the ultrasound probe 11.

Here, for convenience, a direction from the front end portion 12A toward the rear end portion 12B will be referred to as a +Y direction, a width direction of the flat and wide housing 12 that is perpendicular to a Y direction will be referred to as an X direction, and a direction perpendicular to both the X direction and the Y direction will be referred to as a Z direction.

The housing 12 is made of, for example, an insulating resin, and the grip portion 12C has a tubular shape surrounded by four side plate portions extending along a center line C1 extending from the front end portion 12A to the rear end portion 12B. The four side plate portions are composed of a first side plate portion S1 directed in a-Z direction, a second side plate portion S2 directed in a +Z direction on a side opposite to the first side plate portion S1, a third side plate portion S3 connecting the first side plate portion S1 and the second side plate portion S2 and directed in a +X direction, and a fourth side plate portion S4 connecting the first side plate portion S1 and the second side plate portion S2 and directed in a-X direction.

These four side plate portions may be formed by combining a plurality of side plate members.

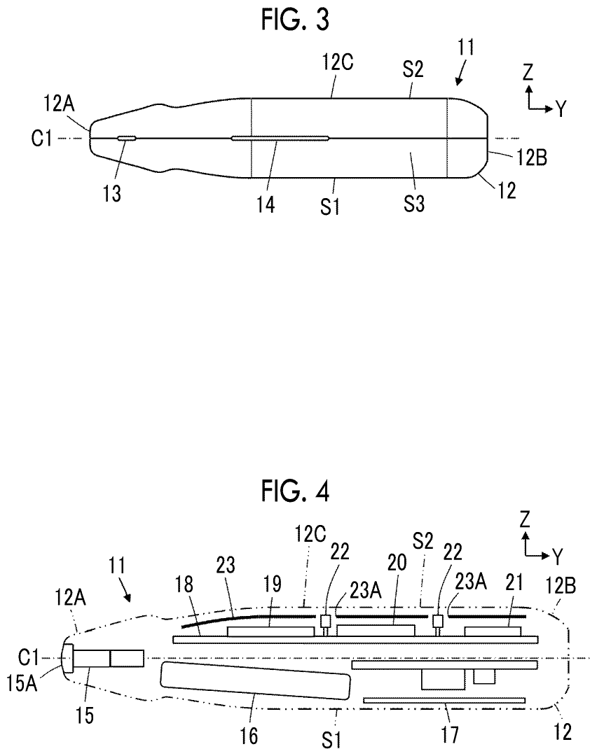

As shown in FIG. 3, the housing 12 has an outer shape in which a thickness in the Z direction gradually decreases from a vicinity of a center portion in the Y direction toward the front end portion 12A along the center line C1, although there is a slight protrusion portion in a case of being viewed in the X direction.

In addition, a protrusion 13 for indicating an orientation of the ultrasound probe 11 is formed to protrude on the +X direction side of the front end portion 12A, and a light-emitting unit 14 extending in the Y direction along the center line C1 is disposed on an outer surface of the third side plate portion S3.

FIG. 4 shows an internal configuration of the ultrasound probe 11.

A transducer array 15 is disposed inside the front end portion 12A of the ultrasound probe 11. The transducer array 15 includes a plurality of transducers arranged in the X direction, and an ultrasound emission surface 15A of the transducer array 15 is exposed from the housing 12 and directed in the −Y direction.

A flat plate-shaped battery 16 is disposed inside the housing 12 at a position offset toward the front end portion 12A side from the grip portion 12C so as to lie along an inner surface of the housing 12. The battery 16 is disposed to be offset toward the −Z direction side with respect to the center line C1.

As described above, since the housing 12 has the outer shape in which the thickness in the Z direction gradually decreases from the vicinity of the center portion in the Y direction toward the front end portion 12A along the center line C1, the battery 16 is disposed at a position offset toward the front end portion 12A side from the grip portion 12C so as to lie along the inner surface of the housing 12, so that the battery 16 is in a state of being inclined relative to the center line C1.

A power receive coil 17 is disposed on the +Y direction side of the battery 16 at a position offset toward the −Z direction side with respect to the center line C1. The power receive coil 17 has a thinner flat plate shape than the battery 16 and is disposed along an inner surface of the first side plate portion S1 of the grip portion 12C. Here, at least a region of the first side plate portion S1 in which the power receive coil 17 is disposed has a planar inner surface and a planar outer surface, and the power receive coil 17 is disposed in a state of being in contact with the inner surface of the first side plate portion S1 or being extremely close to the inner surface of the first side plate portion S1.

In addition, inside the housing 12, a circuit board 18 is disposed at a position offset toward a side opposite to the battery 16 and the power receive coil 17 with respect to the center line C1, that is, inside the second side plate portion S2 of the grip portion 12C. The circuit board 18 extends from the grip portion 12C to the vicinity of the transducer array 15 of the front end portion 12A along an XY plane, and two integrated circuits 19 and 20 and a wireless communication circuit 21 are sequentially mounted on a front surface of the circuit board 18 on the +Z direction side along the center line C1 in the +Y direction.

Furthermore, two temperature sensors 22 connected to the circuit board 18 are disposed inside the housing 12. Among the two temperature sensors 22, one temperature sensor 22 is located between the two integrated circuits 19 and 20, and the other temperature sensor 22 is located between the integrated circuit 20 and the wireless communication circuit 21, and each of the temperature sensors 22 is disposed close to an inner surface of the second side plate portion S2 of the grip portion 12C.

In addition, a sheet-like heat dissipation member 23 is disposed between the circuit board 18 and the inner surface of the second side plate portion S2 of the grip portion 12C, and the two integrated circuits 19 and 20 and the wireless communication circuit 21 mounted on the circuit board 18 are covered with the heat dissipation member 23. The heat dissipation member 23 consists of, for example, a resin sheet in which the thermal conductivity is improved by encapsulating a high thermal conductive filler, and efficiently absorbs heat from the integrated circuits 19 and 20 and the wireless communication circuit 21, which are heat generating bodies during operation, to prevent malfunction and failure of the integrated circuits 19 and 20 and the wireless communication circuit 21 from occurring in advance.

However, the heat dissipation member 23 has two opening portions 23A formed corresponding to positions at which the two temperature sensors 22 are disposed, and the two temperature sensors 22 face the inner surface of the second side plate portion S2 through the corresponding opening portions 23A of the heat dissipation member 23.

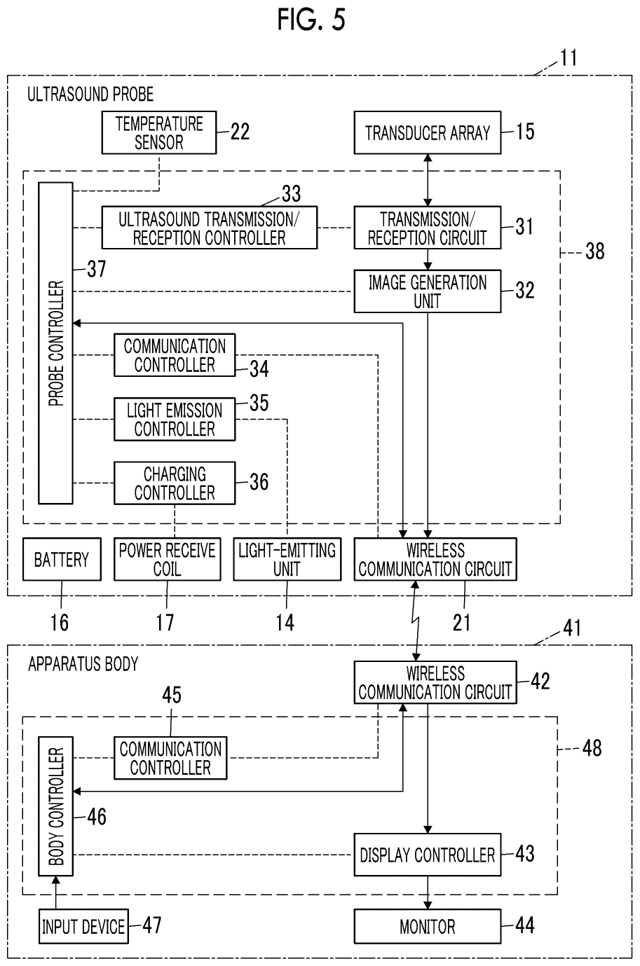

Hereinafter, FIG. 5 shows a configuration of an ultrasound diagnostic apparatus comprising the ultrasound probe 11 according to the first embodiment. The ultrasound diagnostic apparatus comprises the ultrasound probe 11 and an apparatus body 41 according to the first embodiment, and the ultrasound probe 11 and the apparatus body 41 are connected to each other by wireless communication.

The ultrasound probe 11 has a transmission/reception circuit 31 connected to the transducer array 15, and an image generation unit 32 and the wireless communication circuit 21 are sequentially connected to the transmission/reception circuit 31. In addition, an ultrasound transmission/reception controller 33 is connected to the transmission/reception circuit 31. Further, a communication controller 34 is connected to the wireless communication circuit 21, a light emission controller 35 is connected to the light-emitting unit 14, and a charging controller 36 is connected to the power receive coil 17. In addition, a probe controller 37 is connected to the temperature sensors 22, the ultrasound transmission/reception controller 33, the communication controller 34, the light emission controller 35, and the charging controller 36. Here, the wireless communication circuit 21 and the probe controller 37 are connected to each other so as to enable bidirectional exchange of information.

Further, a processor 38 on the ultrasound probe 11 side is formed by the transmission/reception circuit 31, the image generation unit 32, the ultrasound transmission/reception controller 33, the communication controller 34, the light emission controller 35, the charging controller 36, and the probe controller 37.

The apparatus body 41 comprises a wireless communication circuit 42, and a display controller 43 and a monitor 44 are sequentially connected to the wireless communication circuit 42. In addition, a communication controller 45 is connected to the wireless communication circuit 42, and a body controller 46 is connected to the wireless communication circuit 42, the display controller 43, and the communication controller 45. In addition, an input device 47 is connected to the body controller 46. Here, the wireless communication circuit 42 and the body controller 46 are connected to each other so as to enable bidirectional exchange of information.

Further, a processor 48 on the apparatus body 41 side is formed by the display controller 43, the communication controller 45, and the body controller 46.

In addition, the wireless communication circuit 21 of the ultrasound probe 11 and the wireless communication circuit 42 of the apparatus body 41 are connected to each other so as to enable bidirectional exchange of information, so that the ultrasound probe 11 and the apparatus body 41 are connected to each other by wireless communication.

The transducer array 15 of the ultrasound probe 11 includes a plurality of transducers arranged in a one-dimensional or two-dimensional manner. Each of these transducers transmits ultrasound waves in accordance with a drive signal supplied from the transmission/reception circuit 31, receives an ultrasound echo from a subject, and outputs a received signal. Each transducer is formed by, for example, forming electrodes on both ends of a piezoelectric body consisting of a piezoelectric single crystal represented by lead zirconate titanate (PZT), a polymeric piezoelectric element represented by poly vinylidene di fluoride (PVDF), or a piezoelectric single crystal represented by lead magnesium niobate-lead titanate (PMN-PT) solid solution.

The ultrasound transmission/reception controller 33 controls the transmission/reception circuit 31 to transmit an ultrasound beam and receive the ultrasound echo based on an instruction from the probe controller 37.

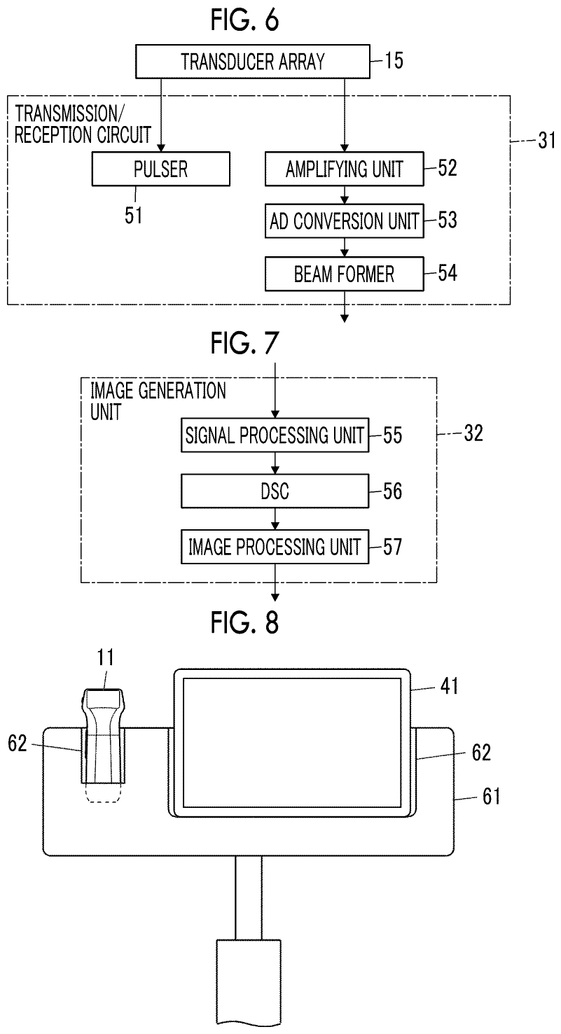

The transmission/reception circuit 31 transmits the ultrasound waves from the transducer array 15 and generates a sound ray signal based on the received signal acquired by the transducer array 15, under the control of the ultrasound transmission/reception controller 33. The transmission/reception circuit 31 includes, as shown in FIG. 6, a pulser 51 connected to the transducer array 15, and an amplifying unit 52, an analog-digital (AD) conversion unit 53, and a beam former 54 which are sequentially connected in series to the transducer array 15.

The pulser 51 includes, for example, a plurality of pulse generators, and supplies each of drive signals to the plurality of transducers by adjusting a delay amount such that the ultrasound waves transmitted from the plurality of transducers of the transducer array 15 form an ultrasound beam based on a transmission delay pattern selected in response to a control signal from the ultrasound transmission/reception controller 33. As described above, in a case in which a pulsed or continuous wave voltage is applied to the electrodes of the transducers of the transducer array 15, the piezoelectric body expands and contracts to generate a pulsed or continuous wave ultrasound wave from each transducer, and the ultrasound beam is formed from the combined wave of these ultrasound waves.

The transmitted ultrasound beam is reflected by a target, for example, a part of the subject, and an ultrasound echo propagates toward the transducer array 15 of the ultrasound probe 11. The ultrasound echo propagating toward the transducer array 15 in this manner is received by each of the transducers constituting the transducer array 15. In such a case, each transducer constituting the transducer array 15 expands and contracts by receiving the propagating ultrasound echo to generate the received signal that is an electric signal, and outputs the received signal to the amplifying unit 52.

The amplifying unit 52 amplifies the signal input from each of the transducers constituting the transducer array 15 and transmits the amplified signal to the AD conversion unit 53. The AD conversion unit 53 converts the signal transmitted from the amplifying unit 52 into digital reception data, and transmits the reception data to the beam former 54. The beam former 54 performs so-called reception focus processing by giving and adding delay with respect to each reception data converted by the AD conversion unit 53, in accordance with a sound velocity or a sound velocity distribution set based on a reception delay pattern selected in accordance with a control signal from the ultrasound transmission/reception controller 33. By the reception focus processing, each reception data, which is converted by the AD conversion unit 53, is phase-added, and the sound ray signal in which the focus of the ultrasound echo is narrowed down is generated. The sound ray signal generated in this way is sent to the image generation unit 32.

As shown in FIG. 7, the image generation unit 32 has a configuration in which a signal processing unit 55, a digital scan converter (DSC) 56, and an image processing unit 57 are sequentially connected in series.

The signal processing unit 55 performs correction of attenuation due to a distance in accordance with a depth of a reflection position of the ultrasound waves on the sound ray signal sent from the transmission/reception circuit 31, and then performs envelope detection processing to generate an image signal (B-mode image signal) which is tomographic image information related to a tissue in the subject.

The DSC 56 converts (raster-converts) the image signal generated by the signal processing unit 55 into an image signal in accordance with a normal television signal scanning method.

The image processing unit 57 performs various types of necessary image processing, such as brightness correction, gradation correction, sharpness correction, and color correction, on the image signal input from the DSC 56, to generate an ultrasound image signal. The ultrasound image signal generated by the image generation unit 32 in this way is sent to the wireless communication circuit 21.

The wireless communication circuit 21 includes an antenna for transmitting and receiving radio waves, and performs wireless communication with the wireless communication circuit 42 of the apparatus body 41. In this case, the wireless communication circuit 21 modulates a carrier based on the image signal sent from the image generation unit 32 to generate a transmission signal, and wirelessly transmits the generated transmission signal to the wireless communication circuit 42 of the apparatus body 41. As the carrier modulation method, for example, amplitude shift keying (ASK), phase shift keying (PSK), quadrature phase shift keying (QPSK), 16 quadrature amplitude modulation (16QAM), or the like is used.

The communication controller 34 controls the wireless communication circuit 21 such that the ultrasound image signal is transmitted with a transmission radio field intensity set by the probe controller 37.

The light emission controller 35 controls the light emission of the light-emitting unit 14 disposed on the outer surface of the third side plate portion S3 of the housing 12 such that various states of the ultrasound probe 11 are represented, under the control of the probe controller 37.

In a case in which the ultrasound probe 11 is disposed in a charger described later, the charging controller 36 controls charging of the battery 16 via the power receive coil 17 with respect to the battery 16 and the power receive coil 17 built in the housing 12.

The temperature sensors 22 disposed inside the housing 12 detect a temperature inside the housing 12, particularly, a temperature in the vicinity of the inner surface of the second side plate portion S2 of the grip portion 12C, and sends the detected temperature to the probe controller 37.

The battery 16 supplies the power to each unit in the ultrasound probe 11.

The probe controller 37 performs control of each unit in the ultrasound probe 11 based on a program or the like stored in advance.

The wireless communication circuit 42 of the apparatus body 41 includes an antenna for transmitting and receiving radio waves, and performs wireless communication with the wireless communication circuit 21 of the ultrasound probe 11. In this case, the wireless communication circuit 42 of the apparatus body 41 receives, for example, a transmission signal wirelessly transmitted from the wireless communication circuit 21 of the ultrasound probe 11 through the antenna, demodulates the received transmission signal, and outputs the ultrasound image signal. The wireless communication circuit 42 of the apparatus body 41 sends the ultrasound image signal output in this way to the display controller 43.

The display controller 43 performs predetermined processing on the ultrasound image signal sent from the wireless communication circuit 42 under the control of the body controller 46, and displays the ultrasound image on the monitor 44.

The monitor 44 displays the ultrasound image under the control of the display controller 43, and includes, for example, a display device such as a liquid crystal display (LCD) or an organic electroluminescence display (organic EL display).

The communication controller 45 controls the wireless communication circuit 42 of the apparatus body 41 such that the wireless communication circuit 42 receives the transmission signal from the wireless communication circuit 21 of the ultrasound probe 11.

The body controller 46 controls each unit of the apparatus body 41 based on a program stored in advance and an operation by the user via the input device 47.

The input device 47 is an input device for the user to perform an input operation, and is configured by, for example, a device such as a keyboard, a mouse, a trackball, a touchpad, and a touch sensor disposed in a state of being superimposed on the monitor 44.

Here, each of the processor 38 on the ultrasound probe 11 side including the transmission/reception circuit 31, the image generation unit 32, the ultrasound transmission/reception controller 33, the communication controller 34, the light emission controller 35, the charging controller 36, and the probe controller 37, and the processor 48 on the apparatus body 41 side including the display controller 43, the communication controller 45, and the body controller 46 may be configured by one or a plurality of types of hardware, and the type of the hardware is not limited. For example, the processor can be configured by hardware such as a central processing unit (CPU), a micro processing unit (MPU), a dedicated circuit such as an application specific integrated circuit (FPGA) for executing specific processing, a graphic processing unit (GPU), or a neural processing unit (NPU). Further, the processor includes each unit or each means that executes various types of processing in the present embodiment. Moreover, the type of hardware may be a combination of different types of hardware. In a case in which a plurality of types of hardware are configured to execute one or a plurality of types of processing of a certain processor, the plurality of types of hardware may exist in devices physically separated from each other or may exist in the same device. Further, in any embodiment, the order of each processing executed by the processor is not limited to the above-described order, and may be changed as appropriate. The hardware is configured by an electric circuit (circuitry) in which circuit elements, such as semiconductor elements, are combined, or the like.

In the first embodiment, the processor 38 on the ultrasound probe 11 side is configured by two integrated circuits 19 and 20 shown in FIG. 4.

Furthermore, the present embodiment may be implemented by hardware, software, firmware, microcode, or a combination thereof. Software, firmware, and microcode are implemented by programs. The program may be, for example, a program module group, and each function thereof may be implemented by a processor configured to execute each function. The program may be a program code or a plurality of code segments stored in one or a plurality of non-transitory computer-readable media (for example, a storage medium and other storages). The program may be stored in the plurality of non-transitory computer-readable media present in devices physically separated from each other. The program code or the code segment can represent any combination of procedures, functions, subprograms, routines, subroutines, modules, software packages, classes, instructions, data structures, or program statements. The program code or the code segment may be connected to another code segment or a hardware circuit by transmitting and receiving information, data, arguments, parameters, or contents in the memory.

In a case in which ultrasound diagnosis is performed by the ultrasound diagnostic apparatus shown in FIG. 5, first, under the control of the ultrasound transmission/reception controller 33 of the ultrasound probe 11, ultrasound beams are transmitted into the subject from the plurality of transducers of the transducer array 15 in accordance with the drive signal from the transmission/reception circuit 31. The ultrasound echo from the subject is received by the plurality of transducers of the transducer array 15, and the received signal, which is an analog signal, is output from the plurality of transducers to the transmission/reception circuit 31. The received signal is amplified by the amplifying unit 52 of the transmission/reception circuit 31, is subjected to AD conversion by the AD conversion unit 53, and is subjected to reception focus processing by the beam former 54, so that the sound ray signal is generated, and the sound ray signal is sent from the transmission/reception circuit 31 to the image generation unit 32.

Further, the image generation unit 32 generates the image signal, which is the tomographic image information related to the tissue in the subject, by performing correction of attenuation of the sound ray signal by the distance in accordance with the depth of the reflection position of the ultrasound waves and the envelope detection processing by the signal processing unit 55, the image signal is converted into the image signal in accordance with the normal television signal scanning method by the DSC 56, and the ultrasound image signal is generated by the image processing unit 57 further performing various types of necessary image processing such as gradation processing.

The ultrasound image signal generated in this way is wirelessly transmitted from the wireless communication circuit 21 of the ultrasound probe 11 to the apparatus body 41 and is received by the wireless communication circuit 42 of the apparatus body 41, and then the ultrasound image is displayed on the monitor 44 via the display controller 43.

The operation of each unit of the ultrasound probe 11 is executed by the power from the battery 16 built in the ultrasound probe 11, but the power of the battery 16 is consumed with the operation, so that it is necessary to charge the battery 16.

FIG. 8 shows the ultrasound probe 11 and the apparatus body 41 held by a holding stand 61 having a charging function. It is assumed that the apparatus body 41 has a form of a portable thin computer commonly referred to as a tablet.

The holding stand 61 has a probe holder 62 and a body holder 63, the ultrasound probe 11 is held by the probe holder 62, and the apparatus body 41 is held by the body holder 63.

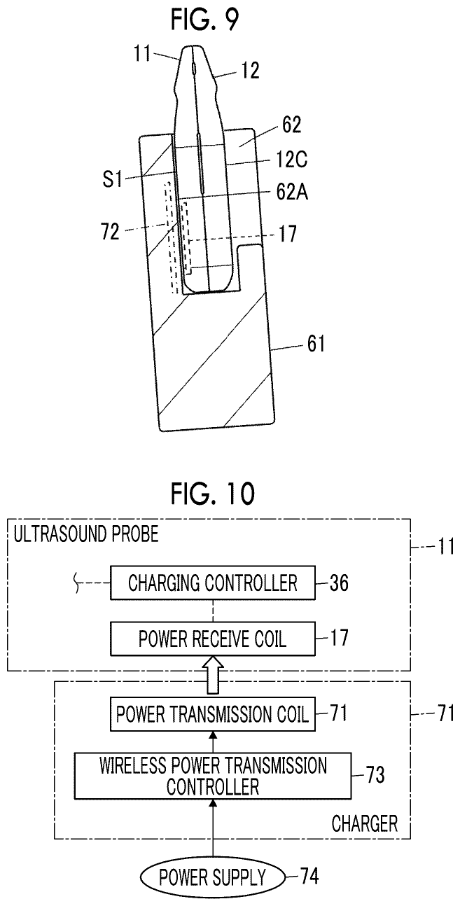

As shown in FIG. 9, the probe holder 62 has a recess portion in which the ultrasound probe 11 is accommodated, and has a planar holding surface 62A that faces the first side plate portion S1 of the grip portion 12C of the housing 12 of the accommodated ultrasound probe 11.

In addition, the probe holder 62 has a charger 71 described later built therein.

As shown in FIG. 10, the charger 71 includes a power transmission coil 72 and a wireless power transmission controller 73 connected to the power transmission coil 72.

The power transmission coil 72 is for transmitting wireless power to the power receive coil 17 of the ultrasound probe 11, and has a flat plate shape as shown in FIG. 9, and is disposed inside the holding surface 62A of the probe holder 62 and close to the holding surface 62A.

The wireless power transmission controller 73 controls the power transmission coil 72 to generate a magnetic field from the power transmission coil 72 by using a power supply voltage supplied from a power supply 74 configured by an alternating-current power supply or a direct-current power supply and to transmit charging power to the power receive coil 17 of the ultrasound probe 11.

Here, at least a region of the first side plate portion S1 of the ultrasound probe 11 in which the power receive coil 17 is disposed has a planar inner surface and a planar outer surface, the power receive coil 17 is disposed in a state of being in contact with the inner surface of the first side plate portion S1 or being extremely close to the inner surface of the first side plate portion S1, and the power transmission coil 72 of the charger 71 built in the probe holder 62 is disposed inside the holding surface 62A of the probe holder 62 and close to the holding surface 62A.

Therefore, as shown in FIG. 9, in a case in which the planar outer surface of the first side plate portion S1 is brought into contact with the planar holding surface 62A of the probe holder 62 to hold the ultrasound probe 11 in the probe holder 62, the power receive coil 17 of the ultrasound probe 11 and the power transmission coil 72 of the charger 71 face each other and are close to each other.

In this state, the wireless power transmission controller 73 of the charger 71 generates the magnetic field from the power transmission coil 72, so that the power receive coil 17 and the power transmission coil 72 are magnetically coupled to each other, and thus the power is transmitted from the power transmission coil 72 to the power receive coil 17. As a result, in the ultrasound probe 11, the battery 16 is charged under the control of the charging controller 36.

It is desirable that a distance between the power receive coil 17 and the power transmission coil 72 during charging is, for example, about 5 mm or less.

As described above, in the ultrasound probe 11, since the power receive coil 17 is disposed along the inner surface of the first side plate portion S1 of the grip portion 12C, and at least the region of the first side plate portion S1 in which the power receive coil 17 is disposed has the planar outer surface, in a case in which the planar outer surface of the first side plate portion S1 is brought into contact with the planar holding surface 62A of the probe holder 62 to hold the ultrasound probe 11 in the probe holder 62, the power receive coil 17 of the ultrasound probe 11 and the power transmission coil 72 of the charger 71 can be made to face each other and close to each other. Therefore, it is possible to efficiently charge the battery 16.

It should be noted that, since at least a part of the outer surface of the second side plate portion S2, among the first side plate portion S1 to the fourth side plate portion S4 that surround the grip portion 12C, disposed on the side opposite to the first side plate portion S1 with the center line C1 interposed therebetween has a curved shape, the ultrasound probe 11 is configured such that the user can easily grip the grip portion 12C and the operability of the ultrasound probe 11 is improved.

In addition, since the protrusion 13 is formed to protrude on the +X direction side of the front end portion 12A of the ultrasound probe 11, the user can easily grasp the orientation of the ultrasound probe 11 due to the presence of the protrusion 13 in a case in which the user grips the grip portion 12C, and the operability is improved.

Further, since the ultrasound probe 11 has the light-emitting unit 14 disposed on the outer surface of the third side plate portion S3 of the grip portion 12C, various states of the ultrasound probe 11 can be notified by changing a way of emitting light from the light-emitting unit 14 under the control of the light emission controller 35.

For example,
Activation state of ultrasound probe 11,
Wireless connection state between ultrasound probe 11 and apparatus body 41,
Remaining capacity of battery 16,
Charging state of battery 16,
Error state, and
Update state of software installed in ultrasound probe 11
are notified by changing the light emission color, the light emission pattern, and the like.

In addition, the temperature of the vicinity of the inner surface of the second side plate portion S2 of the grip portion 12C detected by the two temperature sensors 22 is transmitted to the probe controller 37, and the notification of a heat generation state of the ultrasound probe 11 can be performed by the light emitted from the light-emitting unit 14 under the control of the light emission controller 35.

In general, the surface temperature of the ultrasound probe is limited to a temperature equal to or lower than a temperature predetermined by a safety standard, but, in a case in which the way of the light emission of the light-emitting unit 14 is changed in accordance with the temperature detected by the temperature sensor 22, the user can easily and sensuously grasp the surface temperature of the ultrasound probe 11. In addition, the user may grasp a fact that the surface temperature of the ultrasound probe 11 exceeds a predetermined temperature based on the way of the light emission of the light-emitting unit 14, and may use the fact as a guide for temporarily suspending the use of the ultrasound probe 11.

In a case in which the temperature detected by the temperature sensors 22 has reached a predetermined threshold value, the surface temperature of the ultrasound probe 11 can be lowered by performing a treatment such as adjusting the drive signal supplied from the transmission/reception circuit 31 to the transducer array 15 by the ultrasound transmission/reception controller 33 to lower the frame rate of the ultrasound imaging or stopping the ultrasound imaging.

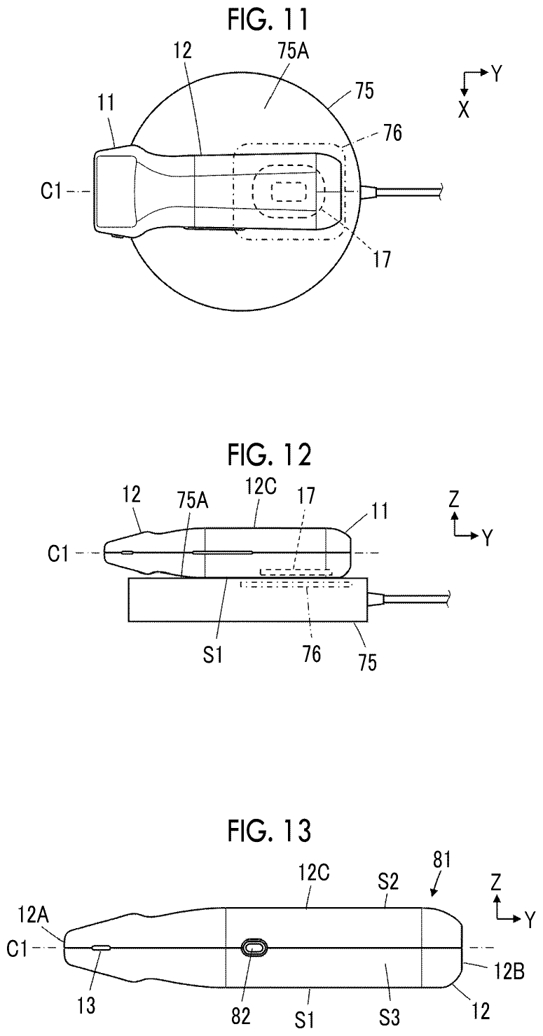

The probe holder 62 of the holding stand 61 shown in FIG. 8 holds the ultrasound probe 11 in an upright state and charges the battery 16, but the present invention is not limited to this, and, for example, a charger 75 as shown in FIGS. 11 and 12 can also be used. The charger 75 has a planar holding surface 75A that extends substantially horizontally, and the ultrasound probe 11 is held on the holding surface 75A of the charger 75 in a state of extending substantially horizontally such that the center line C1 is parallel to the holding surface 75A.

The charger 75 has a flat plate-shaped power transmission coil 76 that is disposed close to the holding surface 75A directly below the holding surface 75A, and as shown in FIG. 12, in a case in which the planar outer surface of the first side plate portion S1 is brought into contact with the planar holding surface 75A of the charger 75 to hold the ultrasound probe 11 on the charger 75, the power receive coil 17 of the ultrasound probe 11 and the power transmission coil 76 of the charger 75 face each other and are close to each other.

Therefore, as in a case of the probe holder 62 of the holding stand 61 shown in FIG. 8, it is possible to efficiently charge the battery 16.

In this case as well, it is desirable that a distance between the power receive coil 17 and the power transmission coil 76 during charging is, for example, about 5 mm or less.

In the first embodiment described above, the protrusion 13 is formed to protrude on the +X direction side of the front end portion 12A of the ultrasound probe 11, but the present invention is not limited to this, and the protrusion 13 can also be formed to protrude on the −X direction side of the front end portion 12A of the ultrasound probe 11.

Similarly, in the first embodiment described above, the light-emitting unit 14 is disposed on the outer surface of the third side plate portion S3 of the grip portion 12C facing the +X direction, but the present invention is not limited to this, and the light-emitting unit 14 may be disposed on the outer surface of the fourth side plate portion S4 of the grip portion 12C facing the −X direction.

### Second Embodiment

FIG. 13 shows an ultrasound probe 81 according to a second embodiment.

The ultrasound probe 81 is obtained by disposing an operation button 82 on the outer surface of the third side plate portion S3 of the grip portion 12C of the housing 12, instead of the light-emitting unit 14, in the ultrasound probe 11 according to the first embodiment, and other configurations of the ultrasound probe 81 are the same as those of the ultrasound probe 11 according to the first embodiment.

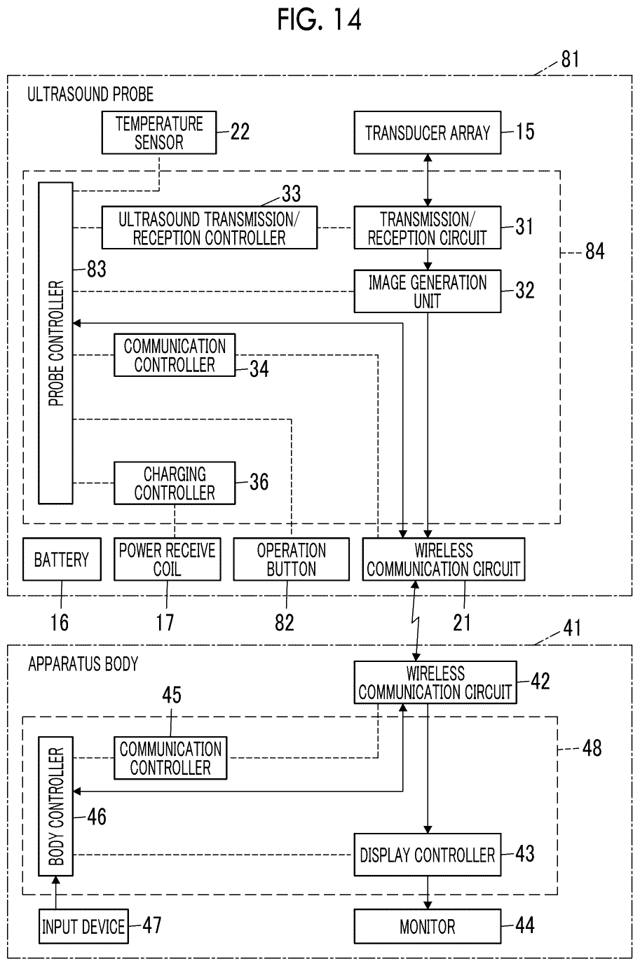

As shown in FIG. 14, in the ultrasound probe 81, a probe controller 83 is connected to the temperature sensors 22, the image generation unit 32, the ultrasound transmission/reception controller 33, the communication controller 34, the charging controller 36, and the operation button 82, and a processor 84 on the ultrasound probe 81 side is formed by the transmission/reception circuit 31, the image generation unit 32, the ultrasound transmission/reception controller 33, the communication controller 34, the charging controller 36, and the probe controller 83.

The probe controller 83 performs control of each unit in the ultrasound probe 81 based on a program or the like stored in advance.

The apparatus body 41 used in the first embodiment is used as it is in the second embodiment, and is wirelessly connected to the ultrasound probe 81.

The operation button 82 is operated by the user who grips the grip portion 12C of the ultrasound probe 81, and the ultrasound probe 81 performs an operation in accordance with the operation content of the operation button 82 under the control of the probe controller 37A.

For example, the operation of the operation button 82 can be used to activate the ultrasound probe 81, establish a wireless connection state between the ultrasound probe 81 and the apparatus body 41, select an ultrasound diagnosis mode, and the like.

In the ultrasound probe 81 according to the second embodiment as well, similarly to the ultrasound probe 11 according to the first embodiment, at least the region of the first side plate portion S1 in the grip portion 12C of the housing 12, in which the power receive coil 17 is disposed, has the planar inner surface and the planar outer surface, and the battery 16 can be efficiently charged using the probe holder 62 shown in FIGS. 8 and 9 or the charger 75 shown in FIGS. 11 and 12.

### Third Embodiment

The ultrasound probe 11 according to the first embodiment includes the image generation unit 32, and the ultrasound image signal generated by the image generation unit 32 is wirelessly transmitted from the wireless communication circuit 21 of the ultrasound probe 11 to the apparatus body 41 as shown in FIG. 5, but the present invention is not limited to this.

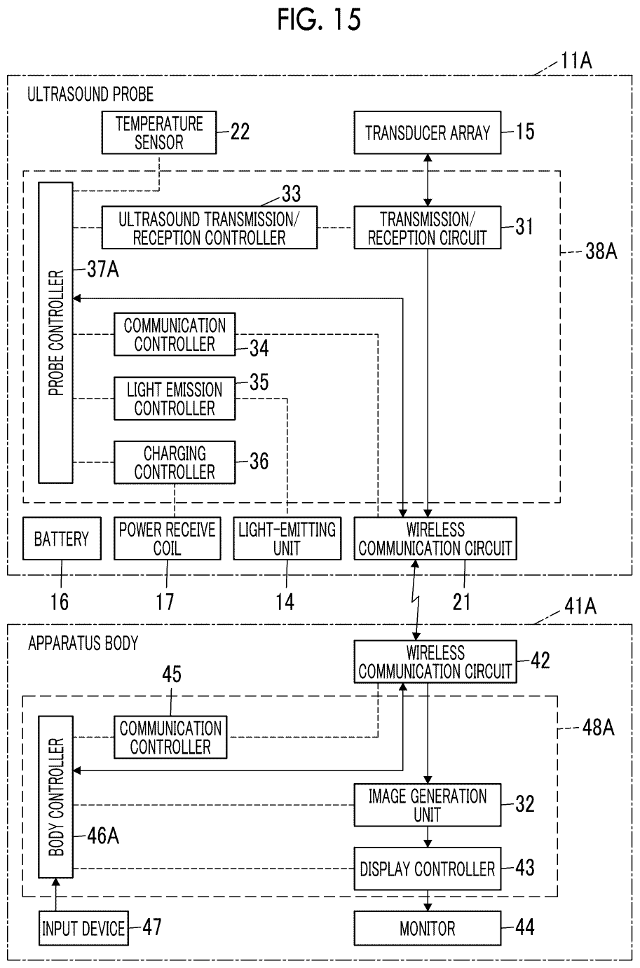

FIG. 15 shows a configuration of an ultrasound diagnostic apparatus comprising an ultrasound probe 11A according to a third embodiment. The ultrasound diagnostic apparatus comprises the ultrasound probe 11A and an apparatus body 41A according to the third embodiment, and the ultrasound probe 11A and the apparatus body 41A are connected to each other by wireless communication.

The ultrasound probe 11A is obtained by deleting the image generation unit 32 in the ultrasound probe 11 according to the first embodiment shown in FIG. 5, directly connecting the wireless communication circuit 21 to the transmission/reception circuit 31, and using a probe controller 37A instead of the probe controller 37, and other configurations of the ultrasound probe 11A are the same as those of the ultrasound probe 11 according to the first embodiment. In addition, the ultrasound probe 11A has the same housing 12 as the housing 12 in the ultrasound probe 11 according to the first embodiment.

The apparatus body 41A is obtained by newly connecting the image generation unit 32 between the wireless communication circuit 42 and the display controller 43 in the apparatus body 41 according to the first embodiment shown in FIG. 5, and connecting the body controller 46A to the display controller 43, the communication controller 45, and the image generation unit 32 instead of the body controller 46, and other configurations of the apparatus body 41A are the same as those of the apparatus body 41 according to the first embodiment.

In the ultrasound probe 11A, the transmission/reception circuit 31, the ultrasound transmission/reception controller 33, the communication controller 34, the light emission controller 35, the charging controller 36, and the probe controller 37A form a processor 38A on the ultrasound probe 11A side.

In addition, in the apparatus body 41A, the image generation unit 32, the display controller 43, the communication controller 45, and the body controller 46A form a processor 48A on the apparatus body 41A side.

The sound ray signal generated in the transmission/reception circuit 31 of the ultrasound probe 11A is wirelessly transmitted from the wireless communication circuit 21 to the apparatus body 41A, the image generation unit 32 performs attenuation correction and envelope detection processing on the sound ray signal received by the wireless communication circuit 42 of the apparatus body 41A to generate the ultrasound image signal, and the ultrasound image is displayed on the monitor 44 via the display controller 43.

In this way, in the ultrasound diagnostic apparatus comprising the ultrasound probe 11A according to the third embodiment as well, the ultrasound image can be displayed on the monitor 44 in the same manner as the ultrasound diagnostic apparatus comprising the ultrasound probe 11 according to the first embodiment.

In addition, the ultrasound probe 11A has the same housing 12 as the housing 12 in the ultrasound probe 11 according to the first embodiment, at least the region of the first side plate portion S1 in the grip portion 12C of the housing 12, in which the power receive coil 17 is disposed, has the planar inner surface and the planar outer surface, so that the battery 16 can be efficiently charged using the probe holder 62 shown in FIGS. 8 and 9 or the charger 75 shown in FIGS. 11 and 12.

In the first embodiment, the apparatus body 41 shown in FIG. 8 has a portable thin computer form commonly referred to as a tablet, but the present invention is not limited to this, and for example, the apparatus body 41 of a stationary type can also be used.

Similarly, the apparatus body 41A according to the third embodiment can also be the apparatus body 41A having a portable thin computer form or a stationary type.

### EXPLANATION OF REFERENCES

11, 11A, 81: ultrasound probe
12: housing
12A: front end portion
12B: rear end portion
12C: grip portion
13: protrusion
14: light-emitting unit
15: transducer array
15A: ultrasound emission surface
16: battery
17: power receive coil
18: circuit board
19, 20: integrated circuit
21, 42: wireless communication circuit
22: temperature sensor
23: heat dissipation member
23A: opening portion
31: transmission/reception circuit
32: image generation unit
33: ultrasound transmission/reception controller
34, 45: communication controller
35: light emission controller
36: charging controller
37, 37A, 83: probe controller
38, 38A, 48, 48A, 84: processor
41, 41A: apparatus body
43: display controller
44: monitor
46, 46A: body controller
47: input device
51: pulser
52: amplifying unit
53: AD conversion unit
54: beam former
55: signal processing unit
56: DSC
57: image processing unit
61: holding stand
62: probe holder
62A. 75A: holding surface
63: body holder
71, 75: charger
72, 76: power transmission coil
73: wireless power transmission controller
74: power supply
82: operation button
C1: center line
S1: first side plate portion
S2: second side plate portion
S3: third side plate portion
S4: fourth side plate portion

What is claimed is:

1. An ultrasound probe as a wireless-charging ultrasound probe that charges a battery built in the ultrasound probe in a wireless manner, the ultrasound probe comprising:
a housing that has a front end portion and a rear end portion, and a grip portion disposed between the front end portion and the rear end portion;
a transducer array that is disposed inside the front end portion of the housing;
the battery that is disposed inside the housing; and
a power receive coil that has a flat plate shape and that is disposed inside the grip portion of the housing,
wherein the housing has four side plate portions that each extend along a center line extending from the front end portion to the rear end portion and that surround the grip portion, and
the power receive coil is disposed along an inner surface of a first side plate portion among the four side plate portions, and at least a region of the first side plate portion in which the power receive coil is disposed has a planar outer surface.

2. The ultrasound probe according to claim 1,
wherein at least a part of an outer surface of a second side plate portion, among the four side plate portions, disposed on a side opposite to the first side plate portion with the center line interposed therebetween has a curved shape.

3. The ultrasound probe according to claim 2, further comprising:
a circuit board that is disposed inside the second side plate portion.

4. The ultrasound probe according to claim 3, further comprising:
a heat dissipation member that is disposed between the circuit board and an inner surface of the second side plate portion.

5. The ultrasound probe according to claim 2, further comprising:
a wireless communication circuit that is disposed inside the second side plate portion.

6. The ultrasound probe according to claim 5, further comprising:
a heat dissipation member that is disposed between the wireless communication circuit and an inner surface of the second side plate portion.

7. The ultrasound probe according to claim 2, further comprising:
a protrusion that indicates an orientation of the ultrasound probe and that is disposed on an outer surface of a third side plate portion, among the four side plate portions, located on a left side of the second side plate portion toward the transducer array or an outer surface of a fourth side plate portion, among the four side plate portions, located on a right side of the second side plate portion toward the transducer array.

8. The ultrasound probe according to claim 3, further comprising:
a protrusion that indicates an orientation of the ultrasound probe and that is disposed on an outer surface of a third side plate portion, among the four side plate portions, located on a left side of the second side plate portion toward the transducer array or an outer surface of a fourth side plate portion, among the four side plate portions, located on a right side of the second side plate portion toward the transducer array.

9. The ultrasound probe according to claim 4, further comprising:
a protrusion that indicates an orientation of the ultrasound probe and that is disposed on an outer surface of a third side plate portion, among the four side plate portions, located on a left side of the second side plate portion toward the transducer array or an outer surface of a fourth side plate portion, among the four side plate portions, located on a right side of the second side plate portion toward the transducer array.

10. The ultrasound probe according to claim 5, further comprising:
a protrusion that indicates an orientation of the ultrasound probe and that is disposed on an outer surface of a third side plate portion, among the four side plate portions, located on a left side of the second side plate portion toward the transducer array or an outer surface of a fourth side plate portion, among the four side plate portions, located on a right side of the second side plate portion toward the transducer array.

11. The ultrasound probe according to claim 6, further comprising:
a protrusion that indicates an orientation of the ultrasound probe and that is disposed on an outer surface of a third side plate portion, among the four side plate portions, located on a left side of the second side plate portion toward the transducer array or an outer surface of a fourth side plate portion, among the four side plate portions, located on a right side of the second side plate portion toward the transducer array.

12. The ultrasound probe according to claim 7, further comprising:
a light-emitting unit that is disposed on the outer surface of the third side plate portion or the outer surface of the fourth side plate portion.

13. The ultrasound probe according to claim 8, further comprising:
a light-emitting unit that is disposed on the outer surface of the third side plate portion or the outer surface of the fourth side plate portion.

14. The ultrasound probe according to claim 9, further comprising:
a light-emitting unit that is disposed on the outer surface of the third side plate portion or the outer surface of the fourth side plate portion.

15. The ultrasound probe according to claim 10, further comprising:
a light-emitting unit that is disposed on the outer surface of the third side plate portion or the outer surface of the fourth side plate portion.

16. The ultrasound probe according to claim 7, further comprising:
an operation button that is disposed on the outer surface of the third side plate portion or the outer surface of the fourth side plate portion.

17. The ultrasound probe according to claim 8, further comprising:
an operation button that is disposed on the outer surface of the third side plate portion or the outer surface of the fourth side plate portion.

18. The ultrasound probe according to claim 9, further comprising:
an operation button that is disposed on the outer surface of the third side plate portion or the outer surface of the fourth side plate portion.

19. The ultrasound probe according to claim 10, further comprising:
an operation button that is disposed on the outer surface of the third side plate portion or the outer surface of the fourth side plate portion.

20. The ultrasound probe according to claim 4, further comprising:
a temperature sensor that is connected to the circuit board and that is disposed close to the inner surface of the second side plate portion,
wherein the heat dissipation member has an opening portion formed corresponding to a position at which the temperature sensor is disposed.
